(19) United States
(12) Patent Application Publication
(10) Pub. No.: US 2020/0185769 A1
(43) Pub. Date: Jun. 11, 2020

(54) INORGANIC/ORGANIC COMPOSITIONS

(71) Applicant: SOLVAY SPECIALTY POLYMERS ITALY S.P.A., Bollate (IT)

(72) Inventors: Christine HAMON, Bollate (IT); Julio A. ABUSLEME, Saronno (IT); Mathieu FENOLL, Everberg (BE); Maxime VAN BEVEREN, Mont-Sur-Marchienne (BE)

(21) Appl. No.: 16/093,485

(22) PCT Filed: Apr. 11, 2017
(86) PCT No.: PCT/EP2017/058592

§ 371 Date: Oct. 12, 2018

(30) Foreign Application Priority Data
Apr. 15, 2016 (EP) 16165613.7

(51) Int. Cl. H01M 10/0565; C08J 3/09; C08J 5/22; H01G 11/56; H01G 11/84

(52) U.S. Cl. CPC H01M 10/0565; C08J 3/097; C08J 5/2237; H01M 2300/0082; H01G 11/84; C08J 2327/16; H01G 11/56

(57) ABSTRACT

The present invention relates to a composition comprising a mixture of organic solvents and of a hybrid inorganic-organic composition comprising a fluoro co-polymer that comprises recurring units deriving from vinylidene difluoride (VDF), to a process for its preparation and to an electrochemical cell comprising an ionically conductive film manufactured using said composition.

### CROSS-REFERENCE TO RELATED APPLICATION

This application claims priority to European application No. 16165613.7, the whole content of this application being incorporated herein by reference for all purposes.

### TECHNICAL FIELD

The present invention relates to a stable composition comprising a mixture of organic solvents and of a hybrid inorganic-organic composition comprising a fluoro co-polymer that comprises recurring units deriving from vinylidene difluoride (VDF), to a process for its preparation and to an electrochemical cell comprising an ionically conductive film manufactured using said composition.

### BACKGROUND ART

Sol-gel preparations comprising hybrid inorganic/organic compositions including fluoropolymers potentially have wide applications in several fields, including, but not limited to, as components of electrochemical cells such as batteries and capacitors.

Solutions and suspension of sol-gel preparations comprising hybrid inorganic/organic compositions including fluoropolymers tend to be unstable and to form gels over time. The gels thus formed have limited use as, in general, they cannot be transformed again into a physical form, such as a solution or a homogeneous suspension, with a viscosity such that it is suitable to be casted, injected or printed. As a result, storage of such compositions is not possible and they must be prepared in situ shortly before their use.

There is still a need for compositions that maintain over time a suitable viscosity, and that can be easily stored and shipped as such.

### SUMMARY OF INVENTION

The present invention provides a composition comprising:

(a) a liquid medium comprising a mixture of at least one organic polar aprotic liquid medium (a1) and of an organic liquid medium (a2), different from (a1), with formula (A2):

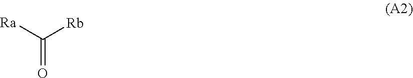

wherein Ra and Rb, equal or different from each other, are C₁-C₁₀ alkyl group, optionally connected to each other to form a ring, wherein the weight/weight ratio of (a1) to (a2) is from 5:95 to 25:75;

(b) a hybrid inorganic/organic composition obtained by the reaction between:

i. a compound (M) of formula (I)

X₄₋ₘAYₘ (I)

wherein X is a hydrocarbon group, optionally comprising one or more functional groups, m is an integer from 1 to 4, A is an element selected from the group consisting of Si, Ti and Zr, and Y is a hydrolysable group selected from the group consisting of an alkoxy group, an acyloxy group and a hydroxyl group and

ii. at least one fluoro co-polymer (F), that comprises recurring units deriving from vinylidene difluoride (VDF) and recurring units deriving from at least a monomer (R1′) having at least one group —O—Rx and/or —C(O)O—Rx, wherein each Rx, optionally independently from the others, is a hydrogen group or a C₁-C₅ hydrocarbon group comprising at least one hydroxyl group, wherein the inorganic residues deriving from compound (M) are bound with the functional groups deriving from —O—Rx and/or —C(O)O—Rx of co-polymer (F), and wherein (b) optionally comprises:

iii. an electrolyte salt (ES-1) and/or

iv. an ionic liquid (IL-1).

In an aspect the present invention provides a process for the preparation of the composition as defined above, comprising the steps of:

i. providing a liquid mixture of at least one organic polar aprotic liquid medium (a1) and of an organic liquid medium (a2), different from (a1), with formula (A2):

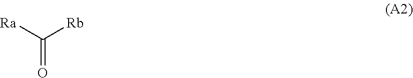

wherein Ra and Rb, equal or different from each other, are C₁-C₁₀ alkyl group, optionally connected to each other to form a ring, wherein the weight/weight ratio of (a1) to (a2) is 5:95 to 25:75;

ii. dissolving or suspending in the liquid mixture of step i. at least one fluoro co-polymer (F), that comprises recurring units deriving from vinylidene difluoride (VDF) and recurring units deriving from at least monomer (R1′) having at least one group —O—Rx and/or —C(O)O—Rx, wherein each Rx, optionally independently from the others, is a hydrogen group or a C₁-C₅ hydrocarbon group comprising at least one hydroxyl group, to obtain a composition (C);

iii. mixing with composition (C) obtained in step ii.:
a compound (M) of formula (I)

X₄₋ₘAYₘ (I)

wherein X is a hydrocarbon group, optionally comprising one or more functional groups, m is an integer from 1 to 4, A is an element selected from the group consisting of Si, Ti and Zr, and Y is a hydrolysable group selected from the group consisting of an alkoxy group, an acyloxy group and a hydroxyl group;
an electrolyte salt (ES-1) and
an ionic liquid (IL-1), to obtain a composition (C-1).

In an aspect, the present invention provides a process for manufacturing an ionically conductive material, such as a film, using the composition as described above.

In an aspect, the present invention provides an electrochemical cell comprising an ionically conductive film manufactured according to said process.

### DESCRIPTION OF EMBODIMENTS

It has been surprisingly found that for certain solvent compositions the viscosity of the sol-gel composition comprising fluoro co-polymers can be well-stabilized and the composition remains in a physical form suitable to be processed for several weeks.

Thus, the compositions according to the invention can be prepared in advance of their intended use and be stored or transported and it is not necessary to prepare the compositions immediately or very shortly prior to their intended use.

The inventors found that the compositions according to the invention are stable, i.e. they do not form gels or solidify, and basically maintain a constant viscosity, for several weeks, generally for at least 2 months. By “constant viscosity” it is here meant that the value of viscosity, as measured by the methods known to the person skilled in the art does not vary by more than 10%. As non-limiting example, in the context of the present invention the viscosities of the compositions in the context of the invention can be measured via the European Standard EN ISO 3219:1994, e.g. at 20° C. and shear rate of 200 s⁻¹.

Unless otherwise specified, in the context of the present invention the amount of a component in a composition is indicated as the ratio between the weight of the component and the total weight of the composition multiplied by 100 (also: “wt %”).

As used hereunder, the term “liquid composition” indicates a free-flowing (i.e. homogeneous) mixture comprising a liquid medium and a polymer, that is dissolved or suspended in said liquid medium so that no solid residue is visible. In other words, the composition according to the invention can be a solution or a suspension, according to the common meaning of these terms as familiar to the person skilled in the art, that designate homogeneous, i.e. single phase, compositions. The composition according to the present invention has a viscosity such that it can move smoothly, at least at a temperature above 0° C., and impregnate at least partially a structure such as a porous membrane or be suitably used in printing or deposition processes. For the avoidance of doubts, in the context of the present invention biphasic compositions, such as those formed by a liquid phase and a solid phase, are not within the definition of liquid composition.

As used here, the term “organic” indicates a chemical compounds comprising a chain of at least two carbon atoms, according to the standard IUPAC nomenclature as commonly familiar to the person skilled in the art.

In the context of the present invention, the term “fluoropolymer hybrid” indicates a composition comprising an organic/inorganic network formed by the cross-linking the inorganic residues deriving from compound (M) and the functional groups deriving from —O—Rx and/or —C(O)O—Rx of co-polymer (F).

For the purpose of the present invention, by vinylidene difluoride (VDF) polymer it is intended to denote a polymer that comprises recurring units derived from vinylidene difluoride (also generally indicated as vinylidene fluoride 1,1-difluoroethylene, VDF), i.e. a polymer derived from the polymerization of recurring units including vinylidene difluoride (VDF), which are present in the final polymer in an amount that is not less than 40% in weight over the total weight of the polymer. The terms “fluoro co-polymer” or “co-polymer” indicate generally a co-polymer of VDF, i.e. polymers wherein the units derived from VDF are present and form less than 100% of the total recurring units.

Preferably, co-polymer (F) contains not less than 50 wt %, more preferably not less than 65 wt %, or 70 wt % or 85% of recurring units deriving from VDF.

The co-polymer (F) typically comprises recurring units (R1′) derived from at least one (meth)acrylic monomer (MA) having formula (II) here below:

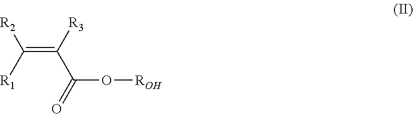

wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group.

Co-polymer (F) typically comprises at least 0.01 wt %, preferably at least 0.02 wt %, more preferably at least 0.03 wt % of recurring units (R1′) derived from at least one (meth)acrylic monomer (MA) having formula (II) as described above.

Co-polymer (F) typically comprises at most 10 wt %, preferably at most 5 wt %, more preferably at most 2 wt % of recurring units (R1′) derived from at least one (meth)acrylic monomer (MA) having formula (II) as described above.

The (meth)acrylic monomer (MA) preferably complies with formula (III) here below:

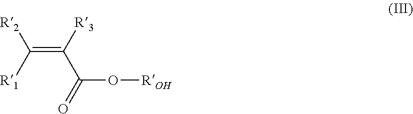

wherein:
R′₁, R′₂ and R′₃ are hydrogen atoms, and
R′_{OH} is a hydrogen atom or a C₁-C₅ hydrocarbon moiety comprising at least one hydroxyl group.

Non-limitative examples of (meth)acrylic monomers (MA) include, notably, acrylic acid, methacrylic acid, hydroxyethyl(meth)acrylate, hydroxypropyl(meth)acrylate, hydroxyethylhexyl(meth)acrylate.

The (meth)acrylic monomer (MA) is more preferably selected from the followings:
hydroxyethyl acrylate (HEA) of formula:

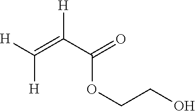

2-hydroxypropyl acrylate (HPA) of either of formulae:

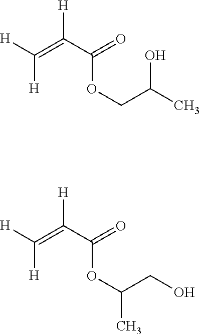

and mixtures thereof.

The (meth)acrylic monomer (MA) is even more preferably hydroxyethyl acrylate (HEA).

The co-polymer (F) preferably comprises at least 0.05 by moles, more preferably at least 0.1% by moles (i.e. in number of moles over the total number of moles of the recurring units in (F)), even more preferably at least 0.2% by moles of recurring units derived from said monomer (MA) having formula (I) as defined above.

The co-polymer (F) preferably comprises at most 10% by moles, more preferably at most 7.5% by moles, even more preferably at most 5% or at most 3% by moles by moles of recurring units derived from said monomer (MA) having formula (I) as defined above.

Preferably, copolymer (F) has intrinsic viscosity from 0.05 to 0.15 L/g, preferably 0.07-0.10 L/g, in DMF at 25° C., e.g. following the method of ASTM D 2857.

Intrinsic viscosity [η] can be determined using the following equation on the basis of the dropping time, at 25° C., of a solution obtained by dissolving polymer (F) in dimethylformamide at a concentration of about 0.2 g/dl, in an Ubbelhode viscosimeter:

$$[ η ] = \frac{{η}_{sp} + Γ \cdot ln {η}_{r}}{( 1 + Γ ) \cdot c}$$

where c is polymer concentration in g/dl;

ηᵣ is the relative viscosity, i.e. the ratio between the dropping time of sample solution and the dropping time of solvent;
ηₛₚ is the specific viscosity, i.e. ηᵣ−1;
Γ is an experimental factor, which for polymer (F) corresponds to 3.

The inventors have found that best results are obtained when co-polymer (F) is a linear semi-crystalline co-polymer.

The term semi-crystalline is intended to denote a polymer which possesses a detectable melting point. It is generally understood that a semi-crystalline polymer possesses a heat of fusion determined according to ASTM D 3418 of advantageously at least 0.4 J/g, preferably of at least 0.5 J/g, more preferably of at least 1 J/g.

The inventors have found that a substantially random distribution of hydrophilic (meth)acrylic monomer (MA) within the polyvinylidene fluoride backbone of the co-polymer (F) advantageously maximizes the effects of the modifying monomer (MA) on both adhesiveness and/or hydrophilic behaviour of the resulting co-polymer, even at low levels of hydrophilic (meth)acrylic monomer (MA) in the composition, without impairing the other outstanding properties of the vinylidene fluoride polymers, e.g. thermal stability and mechanical properties.

Co-polymer (F) can advantageously be a linear co-polymer, that is to say that it can be composed of macromolecules made of substantially linear sequences of recurring units from VDF monomer and (MA) monomer; co-polymer (F) is thus distinguishable from grafted and/or comb-like polymers.

Co-polymer (F) advantageously possesses improved thermal resistance. In particular, polymer (F) undergoes a loss in weight of 1% wt. in TGA analysis under nitrogen following ISO 11358 standard at a temperature of more than 350° C., preferably of more than 360° C., more preferably of more than 380° C.

Co-polymer (F) may comprise recurring units deriving from at least another monomer (R2′), in addition to those derived from the monomer (R1′) as above defined.

Such monomer (R2′) can include at least one conventionally used monomer co-polymerizable with vinylidene fluoride, such as, but not limited to, vinyl fluoride, trifluoroethylene, trifluorochloroethylene (CTFE), tetrafluoroethylene (TFE), hexafluoropropylene (HFP), and fluoroalkyl vinyl ether and their mixtures. In any case, it is preferred that the amount of vinylidene fluoride in co-polymer (F) is at least 70 mol %, so as not to impair the excellent properties of vinylidene fluoride resin, such as chemical resistance, weatherability, and heat resistance. The amount of comonomer (R2′) is preferably below 10 mol %, more preferably below 5 mol % or below 2 mol % over the total number of moles of recurring units in co-polymer (F). More preferably, co-polymer (F) is a ter-polymer formed by recurring units of vinylidene fluoride (VDF), HFP and HEA as defined above.

The composition (C) can optionally comprise at least one other component, in addition to co-polymer (F), and to an electrolyte salt (ES-1), compound (M) of formula (I) as defined above and ionic liquid (IL-1). Preferably, said at least one optional component are selected from an antifoam agent, a surfactant, an anti-bacterial agent, a filler and mixtures thereof. Typically, such optional components, when present, are in an amount lower than 15 wt % over the weight of the composition (C), preferably below 10, 7, 5 or 3 wt %.

Preferably, in the composition according to the invention, compound (M) is an alkoxysilane, optionally carrying functional groups on the alkoxy chains, wherein each X group can be the same or different from the other X groups and is a C₁-C₈ alkyl chain, more preferably wherein (M) is tetramethoxysilane (TMOS), tetraethoxysilane (TEOS), 3-(triethoxysilyl)propylisocyanate (TSPI) or mixtures thereof. Most preferably, the compound (M) is tetraethoxysilane (TEOS), 3-(triethoxysilyl)propylisocyanate (TSPI) or a mixture of TSPI and TEOS.

Preferably, the hybrid organic/inorganic component (b) of the composition of the invention is obtained via reaction of compound (M) in the molar amount from 80% to 120%, preferably 100-110%, of the (MA) monomers of co-polymer (F) present in the composition.

In the context of the present invention, the term “functional groups” indicates chemical moieties different from alkyl chains and aromatic rings, which can be an atom, or a group of atoms that has similar chemical properties whenever it occurs in different compounds, defines the characteristic physical and chemical properties of families of organic compounds (according to the definition of the IUPAC Gold Book 2^{nd} Edition), and which can optionally react to form functionalized or cross-linked species. Non-limiting examples of functional groups are isocyanates, cyanates, cyano groups, esters, amides, carboxylic acids, amines, halides. Preferably, in the composition according to the invention, (b) comprises at least one solid inorganic filler selected from an inorganic oxide, preferably SiO₂, TiO₂, ZnO, Al₂O₃ and mixed oxides, an alkaline or alkaline earth metal sulphate, carbonate, sulphide or mixtures thereof.

Preferably, in the composition according to the invention, the electrolyte salt (ES-1), when present, is a lithium salt, preferably lithium bistrifluoromethanesulfonimide and/or lithium bis(fluorosulfonyl)imide.

Preferably, in the composition according to the invention, the ionic liquid (IL) is selected from those comprising as cation a sulfonium ion or an imidazolium, pyridinium, pyrrolidinium or piperidinium ring, said ring being optionally substituted on the nitrogen atom and comprising as anion those chosen from halides anions, perfluorinated anions and borates, preferably wherein (IL) is Pyr13TFSI (N-propyl-N-methylpyrrolidinium bis(trifluoromethanesulfonyl)imide).

The inventors have found that certain specific combinations of solvents are particularly suitable to provide compositions having stable viscosity over time.

In the context of the present invention, the term “polar solvent” indicates a solvent with a comparatively high relative permittivity (or dielectric constant), that is greater than 15, preferably higher than 22, and a sizable permanent dipole moment, preferably higher than 2.80 S/cm³ at 20° C. (e.g with reference to Ullmann's Encyclopedia of Industrial Chemistry, 2012, Wiley-VCH Verlag, vol. 33, “Solvents”, Table 11, page 634 and Table 15, page 651).

Preferably, in the composition according to the invention the organic polar aprotic liquid medium (a1) is an aprotic polar solvent, i.e. a dipolar non-protogenic solvent having according to the IUPAC definition in the “Compendium of Chemical Terminology”, 2nd ed. (the “Gold Book”), compiled by A. D. McNaught and A. Wilkinson. Blackwell Scientific Publications, Oxford (1997)”, doi:10.1351/goldbook.D01751.

Preferably, the structural formula of (a1) in the composition of the present invention does not comprise a ketone group.

Preferably, in the composition according to the invention (a1) is selected from the group consisting of dimethyl sulfoxide (DMSO), dimethylformamide (DMF), dimethyl acetamide (DMA), N-methylpyrrolidone (NMP), and mixtures thereof and the organic liquid medium (a2) is selected from the group consisting of cyclohexanone, acetone, methyl ethyl ketone (MEK), and mixtures thereof.

More preferably, in the composition according to any of the preceding claims, (a1) is DMSO and (a2) is cyclohexanone.

The inventors surprisingly found that compositions that do not form gels and have stable viscosity over time are obtained exclusively when liquid media (a1) and (a2) are used in specific ranges of their weight/weight ratio.

Preferably, in the composition of the invention the (a1): (a2) weight/weight ratio is 10:90 to 20:80, preferably 12:88 to 15:85. In a particularly preferred embodiment, (a1) and (a2) are, respectively, DMSO and cyclohexanone and their weight/weight ratio is 10:90 to 20:80.

Preferably, the composition according to the invention comprises from 1 to 15%, preferably from 2 to 10% or from 5 to 8% in weight based on the total weight of the composition, of the co-polymer (F), more preferably from 4 to 6% when (F) does not comprise a monomer (R2′) and from 8 to 12% when (F) comprises a co-monomer (R2′) as defined above.

Preferably, the composition according to the invention comprises from 15 to 40% of (b), more preferably from 30 to 20%, in weight based on the total weight of the composition.

In an aspect, the present invention provides a process for the preparation of the composition as defined above, comprising the steps of:

i. providing a liquid mixture of at least one organic polar aprotic liquid medium (a1) and of an organic liquid medium (a2), different from (a1), with formula (A2):

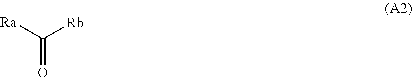

wherein Ra and Rb, equal or different from each other, are C-₁-C₁₀ alkyl group, optionally connected to each other to form a ring, wherein the weight/weight ratio of (a1) to (a2) is 5:95 to 25:75;

ii. dissolving or suspending in the liquid mixture of step i. at least one fluoro co-polymer (F), that comprises recurring units deriving from vinylidene difluoride (VDF) and recurring units deriving from at least monomer (R1′) having at least one group —O—Rx and/or —C(O)O—Rx, wherein each Rx, optionally independently from the others, is a hydrogen group or a C₁-C₅ hydrocarbon group comprising at least one hydroxyl group, to obtain a composition (C);

iii. mixing with composition (C) obtained in step ii.:
a compound (M) of formula (I)

X₄₋ₘAYₘ (I)

wherein X is a hydrocarbon group, optionally comprising one or more functional groups, m is an integer from 1 to 4, A is an element selected from the group consisting of Si, Ti and Zr, and Y is a hydrolysable group selected from the group consisting of an alkoxy group, an acyloxy group and a hydroxyl group;
an electrolyte salt (ES-1) and
an ionic liquid (IL-1), to obtain a composition (C-1).

Preferably, the process according to the invention comprises the additional step iv. of stirring the composition (C-1) obtained in step iii., optionally heating to a temperature comprised between 35° C. and the boiling temperature of the lowest boiling liquid medium (a1) or (a2).

Preferably, in the process according to the invention, step iv. is carried out after the composition (C-1) has turned partially or completely into a gel (as evaluated, e.g. by means of visual inspection).

Preferably, step iv. is carried out under stirring, e.g. with a magnetic bar at 800 rpm, or by mixing with a mechanical mixer or blender such as an orbitary mixer, a paddle mixer or other types commonly used in the chemical industry and known to the person skilled in the art.

As non-limiting examples, in step iv. the composition can be mechanically stirred at 20° C. to 35° C. on a laboratory scale (e.g. 200 ml vessel) at 1200 rpm for 1 min; 2000 rpm for 3 min; at 800 rpm for 1 min; at 2000 rpm for 5 min.

Optionally, the composition can be heated at a temperature from 35° C. to 100° C., such as from 40 to 80° C., from 50 to 70° C. or from 55 to 60° C. during step iv.

Preferably, in the process according to the invention (a1) is DMSO and (a2) is cyclohexanone and in step iv. the composition is heated to 60° C.

Preferably, heating of the composition in step iv. is carried out for 6 to 24 hours, more preferably from 10 to 20 hours, even more preferably from 12 to 18 hours.

In an aspect, the present invention relates to a process for manufacturing an ionically conductive film using the composition as described above.

The process of film manufacturing according to the present invention is not particularly limited and any process known to the person skilled in the art can be used. Non-limiting examples of such process for manufacturing are screen-printing and casting.

In an aspect, the present invention provides an electrochemical cell comprising an ionically conductive film manufactured according to said process.

By the term “electrochemical cell”, it is hereby intended to denote an electrochemical assembly comprising a positive electrode, a negative electrode and a liquid, solid or gel-state electrolyte, and a monolayer or multilayer separator placed between said electrodes.

Non-limitative examples of suitable electrochemical devices include, notably, secondary batteries, especially, alkaline or an alkaline-earth secondary batteries such as lithium ion batteries, and capacitors, especially lithium ion-based capacitors and electric double layer capacitors (“supercapacitors”).

Should the disclosure of any patents, patent applications, and publications which are incorporated herein by reference conflict with the description of the present application to the extent that it may render a term unclear, the present description shall take precedence.

The following examples are provided to illustrate practical embodiments of the invention, with no intention to limit its scope.

### EXPERIMENTAL PART

### Raw Materials

Co-polymer 1: 99.2 VDF-0.8 mol % HEA

Co-polymer 2 (ter-polymer): 96.5 VDF-2.7 mol % HFP-0.8 mol % HEA

### Measurement of the Ionic Conductivity (σ)

The solid electrolyte separator is placed in a ½ inch stainless steel Swagelok-cell prototype. The resistance of the solid polymer electrolyte separator was measured and the ionic conductivity (σ) was obtained using the following equation:

$$σ = \frac{d}{( {R}_{b} \times S )}$$

wherein d is the thickness of the film, R_{b} the bulk resistance and S is the area of the stainless steel electrode.

### Measurement of the Viscosity of the Compositions According to the Invention

The viscosity was measured using a rheometer Model MCR301 from Anton Paar. The measurements were performed with cone-plate geometry (CP50-1). Cone had a diameter of 50 mm and angle of 1 degree. The viscosity values are reported at shear rate of 200 s⁻¹.

Flow curves are performed which consist in reporting the viscosity evolution with shear rate. In a typical flow curve, viscosity drops steeply as the shear is applied and remains substantially constant up to and beyond 200 s⁻¹.

### General Procedure of Manufacturing of the Composition

### Preparation of the Co-Polymer Composition (5 wt %)

Co-polymer 1, Solvent: cyclohexanone/DMSO (80/20 wt/wt)

The co-polymer powder is pre-dried at 80° C. under vacuum overnight (or at least 4 h). A 5 wt % solution is prepared in a glass bottle at 60° C.

### Preparation of the Electrolyte Solution

Electrolyte solution (ES): 0.5 M LiTFSI in PYR13TFSI

The electrolyte solution is prepared in a bottle glass inside a glove box. The PYR13TFSI and LiTFSI are stored in a glove box. It is recommended to degas the ionic liquid before introducing it in the glove box. Once prepared, the electrolyte solution is stored under ambient atmosphere. The electrolyte solution so obtained has an ionic conductivity of 2.4×10⁻³ S/cm at 25° C.

### Preparation of the Composition According to the Invention

The composition according to the invention is prepared in a glass bottle. The electrolyte solution (ES) and the TEOS are added to the PVDF solution. The solution is mixed with a magnetic stirrer for 10 min at ambient temperature. A mixture was obtained containing 19% by volume (23% by weight) of co-polymer 1. 75% by volume (71% by weight) of the electrolyte solution and 6% by volume (6% by weight) of silica (equivalent amount of TEOS fully condensated). The formic acid is then optionally added. For the preparation of thin film, the molar ratio formic acid/TEOS is 2. After the addition of the formic acid, the solution is vigorously stirred with the magnet stirrer for 30 s.

### Procedure for the Stirring Step (iv)

The solution is stored at 20-25° C. for 7 days. It is then magnetically stirred at 60° C. during 18 h or stirred at 20° C. using a mechanical mixer (Speedymixer®) for 5-10 minutes at up to 1000 rpm. The solution is then cooled to room temperature.

### Examples A (Solvent Mixtures Compared to DMF)

Example 1: Composite solution F3-A (5% co-polymer 1 in 80 wt % Cyclohexanone/20 wt % DMSO+ES+TEOS)

Comparative Example 1: Composite solution F3-B (5% Co-polymer 1 in 50 wt % Cyclohexanone/50 wt % DMSO+ES+TEOS)

Comparative Example 2: Composite solution F3-C (10 wt % Co-polymer 1 in DMF+ES+TEOS)

Comparative Example 3: Composite solution F3-D (5% Co-polymer 1 in DMF+ES+TEOS)

The compositions comprising DMF alone or in mixture cyclohexanone/DMSO 1:1 as the liquid medium showed an increase of viscosity (formation of gel-like compositions) after the stirring step (iv). Stabilization of viscosity (no formation of gel-like composition) over time after the stirring step (iv) was achieved only in case of the composition according to the invention wherein the DMSO/cyclohexanone ratio equals to 20/80.

Table 1 (t0=immediately after the stirring step (iv); T 90 h=90 h after the stirring step (iv))

TABLE 1

viscosity (mPa · s)

| | t 0 | T 90 h |
|---|---|---|
| Ex 1 | 41 | 58 |
| Comp. Ex 1 | 47 | 173 |
| Comp. Ex 2 | 74 | 793 |
| Comp. Ex 3 | 10 | — |
| | (Viscosity too low) | |

### Examples B (Solvent Mixture Ratios)

Example 1: Composite solution F3-A (5% PVDF in 80% Cyclohexanone/20% DMSO+ES+TEOS)

Comparative Example 1: Composite solution F3-B (5% PVDF in 50% Cyclohexanone/50% DMSO+ES+TEOS)

Comparative Example 5: Composite solution F3-E (5% PVDF in 70% Cyclohexanone/30% DMSO+ES+TEOS)

Comparative Example 6: Composite solution F3-F (5% PVDF in 60% Cyclohexanone/40% DMSO+ES+TEOS)

Rheological properties at 200 s−1 of the solutions after stabilization step at 60° C. for 18 h

TABLE 2

| | viscosity (mPa · s) | | | | |
|---|---|---|---|---|---|
| | DMSO/ | | | | |
| | Cyclohexanone | | | | |
| | Wt ratio | t 0 | t 24 h | t 89 h | t 139 h |
| Ex 1 | 20/80 | 41 | 57 | 58 | |
| Comp Ex 1 | 50/50 | 47 | 131 | 173 | |
| Comp Ex 5 | 30/70 | 62 | 104 | | 140 |
| Comp Ex 6 | 40/60 | 51 | 113 | | 139 |

In comparative examples 5 and 6: no gel formation over more than 1 week, however, constant increase of viscosity (no stabilization of the solution) was observed.

Stabilization of viscosity was observed only with a ratio 20/80 DMSO/cyclohexanone (example 1).

In comparative examples 5 and 6: no gel formation over more than 1 week, however constant increase of viscosity (no stabilization of the solution) was observed.

### Examples C (PVDF Terpolymer-Co-Polymer 2)

Example 2: Composite solution F3-G (10% Co-polymer 2 in 80% Cyclohexanone/20% DMSO+ES+TEOS)

Comparative Example 7: Composite solution F3-H (10% Co-polymer 2 in 50% Cyclohexanone/50% DMSO+ES+TEOS)

Table 3

Rheological properties at 200 s−1 of the solutions after stabilization step at 60° C. for 18 h

Stabilization with co-polymer 1 is obtained at high concentration (10%) using the composition according to the invention. At high concentration (10%), the solvent ratio 20/80 DMSO/cyclohexanone allows viscosity stabilization, that it is not observed with a solvent ratio 50/50.

TABLE 3

| Viscosity | t 0 h | t 3 h | t 20 h | t 40 h |
|---|---|---|---|---|
| Ex 2 | 157 | 220 | 238 | 233 |
| Comp Ex 7 | 87 | 113 | 192 | 269 |

### Examples D (Other Solvents)

Example 3: Composition F3-I (5% Co-polymer 1 in 80% Cyclohexanone/20% DMF+ES+TEOS)

Example 4: Composition F3-J (5% Co-polymer 1 in 80% MEK/20% DMF+ES+TEOS)

Stability of the compositions was evaluated by visual inspection (no presence of gel) after 1 month of storage following treatment at 60° C. for 18 h.

TABLE 4

| Example | After 1 month |
|---|---|
| Ex. 3 | Stable solution |
| Ex. 4 | Stable solution |

### Screen-Printing

A rubber blade squeegee is used in a system with a polyester mesh.

Characteristics of the mesh: thickness: 240 μm; Angle: 45°; Patterns size: 2.5×2.5 cm, 5×5 cm and 10×10 cm.

Viscosity for screen-printing: 20-50 mPa·s up to 1-10 Pa·s

A very important parameter for this method is a low viscosity variation, which should be at maximum 15%-20% for one screen print.

Starting from the composition according to the invention, a film is prepared by multiple printing steps. The starting composition did not form a gel during the multiple printing procedure. After each printing, a drying step is performed at 20-25° C. for 60 min and the membrane so obtained is then placed in the oven at 70° C. for 40 min. A final thermal post-treatment is done in an oven at 80° C. or 150° C. during 40 min. Stand-alone films can be obtained from the composition according to the invention using standard techniques.

1. A composition comprising:
(a) a liquid medium comprising a mixture of at least one organic polar aprotic liquid medium (a1) and of an organic liquid medium (a2), different from (a1), with formula (A2): 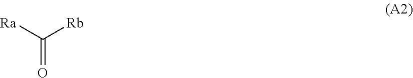
wherein Ra and Rb, equal or different from each other, are C₁-C₁₀ alkyl group, optionally connected to each other to form a ring, wherein the weight/weight ratio of (a1) to (a2) is 5:95 to 25:75;
(b) a hybrid inorganic/organic composition obtained by the reaction between:
i. a compound (M) of formula (I)
X₄₋ₘAYₘ (I)
wherein X is a hydrocarbon group, optionally comprising one or more functional groups, m is an integer from 1 to 4, A is an element selected from the group consisting of Si, Ti and Zr, and Y is a hydrolysable group selected from the group consisting of an alkoxy group, an acyloxy group and a hydroxyl group and
ii. at least one fluoro co-polymer (F), that comprises recurring units derived from vinylidene difluoride (VDF) and recurring units derived from at least a monomer (R1′) having at least one group —O—Rx and/or —C(O)O—Rx, wherein each Rx, optionally independently from the others, is a hydrogen group or a C₁-C₅ hydrocarbon group comprising at least one hydroxyl group wherein the inorganic residues derived from compound (M) are bound with the groups derived from —O—Rx and/or —C(O)O—Rx of co-polymer (F), and wherein (b) optionally comprises:
iii. an electrolyte salt (ES-1) and/or
iv. an ionic liquid (IL-1).

2. The composition according to claim 1, wherein the organic polar aprotic liquid medium (a1) is selected from the group consisting of dimethyl sulfoxide (DMSO), dimethylformamide (DMF), dimethyl acetamide (DMA), N-methylpyrrolidone (NMP), and mixtures thereof and the organic liquid medium (a2) is selected from the group consisting of cyclohexanone, acetone, methyl ethyl ketone (MEK), and mixtures thereof.

3. The composition according to claim 1, wherein (a1) is DMSO and (a2) is cyclohexanone.

4. The composition according to claim 1, wherein the (a1):(a2) weight/weight ratio is 10:90 to 20:80.

5. The composition according to claim 1, wherein compound (M) is an alkoxysilane, optionally carrying functional groups on the alkoxy chains.

6. The composition according to claim 1, wherein (b) comprises at least one solid inorganic filler selected from an inorganic oxide, an alkaline or alkaline earth metal sulphate, carbonate, sulphide or mixtures thereof.

7. The composition according to according to claim 1, wherein the monomer (R1′) is a (meth)acrylic monomer of formula (II): 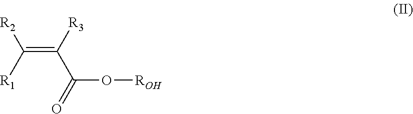
wherein each of R₁, R₂ and R₃, equal to or different from each other, is independently a hydrogen atom or a C₁-C₃ hydrocarbon group, and Rₓ is a hydrogen atom or a C₁-C₅ hydrocarbon moiety comprising at least one hydroxyl group.

8. The composition according to claim 1, wherein fluoro co-polymer (F) further comprises at least a monomer (R2′) different from (R1′).

9. The composition according to claim 6, wherein the at least one monomer (R2′) in the co-polymer (F) is selected from vinyl fluoride, trifluoroethylene, trifluorochloroethylene, tetrafluoroethylene, hexafluoropropylene, a fluoroalkyl vinyl ether and their mixtures.

10. The composition according to claim 1, wherein the electrolyte salt (ES-1) is a lithium salt.

11. The composition according to claim 1, wherein ionic liquid (IL) is selected from those comprising as cation a sulfonium ion or an imidazolium, pyridinium, pyrrolidinium or piperidinium ring, said ring being optionally substituted on the nitrogen atom and comprising as anion those chosen from halides anions, perfluorinated anions and borates.

12. A process for the preparation of the composition according to claim 1, the method comprising:
i. providing a liquid mixture of at least one organic polar aprotic liquid medium (a1) and of an organic liquid medium (a2), different from (a1), with formula (A2): 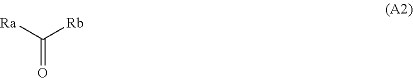
wherein Ra and Rb, equal or different from each other, are C₁-C₁₀ alkyl group, optionally connected to each other to form a ring, wherein the weight/weight ratio of (a1) to (a2) is 5:95 to 25:75;
ii. dissolving or suspending in the liquid mixture of step i. at least one fluoro co-polymer (F), that comprises recurring units derived from vinylidene difluoride (VDF) and recurring units derived from at least monomer (R1′) having at least one group —O—Rx and/or —C(O)O—Rx, wherein each Rx, optionally independently from the others, is a hydrogen group or a C₁-C₅ hydrocarbon group comprising at least one hydroxyl group, to obtain a composition (C);
iii. mixing with composition (C):
a compound (M) of formula (I)
X₄₋ₘAYₘ (I)
wherein X is a hydrocarbon group, optionally comprising one or more functional groups, m is an integer from 1 to 4, A is an element selected from the group consisting of Si, Ti and Zr, and Y is a hydrolysable group selected from the group consisting of an alkoxy group, an acyloxy group and a hydroxyl group;
an electrolyte salt (ES-1) and
an ionic liquid (IL-1), to obtain a composition (C-1).

13. The process according to claim 12, further comprising the step of iv. stirring the composition (C 1), optionally heating to a temperature comprised between 35° C. and the boiling temperature of the lowest boiling liquid medium (a1) or (a2).

14. A process for manufacturing an ionically conductive film using the composition of claim 1.

15. An electrochemical cell comprising an ionically conductive film manufactured according to the process of claim 14.

16. The composition according to claim 4, wherein the (a1):(a2) weight/weight ratio is 12:88 to 15:85.

17. The composition according to claim 5, wherein compound (M) is selected from the group consisting of tetramethoxysilane (TMOS), tetraethoxysilane (TEOS) and 3-(triethoxysilyl)propylisocyanate (TSPI).

18. The composition according to claim 6, wherein (b) comprises at least one inorganic oxide selected from the group consisting of SiO₂, TiO₂, ZnO, Al₂O₃, mixed oxides, and mixtures thereof.

19. The composition according to claim 10, wherein the electrolyte salt (ES-1) is at least one lithium salt selected from the group consisting of lithium bistrifluoromethanesulfonimide, lithium bis(fluorosulfonyl)imide and mixtures thereof.

20. The composition according to claim 11, wherein ionic liquid (IL) is N-propyl-N-methylpyrrolidinium bis(trifluoromethanesulfonyl)imide.
